(19) United States
(12) Patent Application Publication
(10) Pub. No.: US 2006/0004135 A1
(43) Pub. Date: Jan. 5, 2006

(54) Polymerizable macrocyclic oligomer masterbatches containing dispersed fillers

(76) Inventors: Michael Steven Paquette, Midland, MI (US); Robert Paul Dion, Midland, MI (US); Martin C. Beebe, Standish, MI (US); Peter C. LeBaron, Midland, MI (US); Mark A. Barger, Midland, MI (US); Parvinder S. Walia, Midland, MI (US)

Correspondence Address: GARY C. COHN, PLLC, 1147 NORTH FOURTH STREET, UNIT 6E, PHILADELPHIA, PA, 19123, US

(21) Appl. No.: 11/154,882

(22) Filed: Jun. 16, 2005

Related U.S. Application Data
(60) Provisional application No. 60/581,189, filed on Jun. 18, 2004.

(51) Int. Cl. C08K 3/34

(52) U.S. Cl. 524/445

(57) ABSTRACT

Composites of macrocyclic oligomers and a filler material are made in a masterbatch process. The masterbatch contains at least 15% by weight of the filler material. The filler material is preferably a submicron sized material and is especially a clay or other layered material that can become at least partially exfoliated. The masterbatch can be let down into more of the macrocyclic oligomer, another polymer, another polymerizable material and subjected to polymerization conditions to form a nanocomposite material. Alternatively, the masterbatch can be polymerized to a high or intermediate molecular weight, and then blended with additional oligomer, polymer or other polymerizable material.

### CROSS-REFERENCE TO RELATED APPLICATION

This application claims benefit of U.S. Provisional Application No. 60/581,189, filed 18 Jun. 2004.

### BACKGROUND OF THE INVENTION

The invention relates to polymers derived from macrocyclic oligomers containing organoclay fillers. Furthermore, the invention relates to articles prepared from nanodispersions of a clay filler in a macrocyclic oligomer.

Macrocyclic oligomers have been developed which form polymeric compositions with desirable properties such as strength, toughness, high gloss and solvent resistance. Among preferred macrocyclic oligomers are macrocyclic polyester oligomers such as those disclosed in U.S. Pat. No. 5,498,651, incorporated herein by reference. Such macrocyclic polyester oligomers are excellent starting materials for producing polymer composites because they exhibit low melt viscosities, which facilitate good impregnation and wet out in composite applications. Furthermore, such macrocyclic oligomers are easy to process using conventional processing techniques. However, such polymer compositions do not have heat deflection temperatures that are high enough to permit them to be suitable for some high-temperature applications. Therefore, nanocomposites of such materials have been developed wherein layered clay platelets are dispersed in the polymeric matrix. Such compositions are disclosed in U.S. Pat. No. 5,530,052 and in PCT application PCT/US03/041476, filed Dec. 19, 2003, both incorporated herein by reference.

The dispersed clays in these nanocomposites provide improved thermal properties and reinforcement to the polymer, while other useful properties such as ductility are maintained at acceptable values. This property enhancement depends greatly on the extent to which the clay becomes distributed throughout the polymer. These clay fillers appear naturally in the form of “stacked” high aspect ratio platelets which are of the order of 0.5-2 nm thick. Maximum benefit is obtained from these clay fillers when the platelets become separated (or “exfoliated) from each other as the clay is dispersed into the polymer. However, it is in practice difficult to achieve this effect economically, as adequate mixing normally cannot be achieved within the context of normal melt processing applications, without some modification of the process. The problem is exacerbated because the clay particles and/or organic modifiers on the clay can degrade if conditions are too stringent. Therefore, practical methods by which the clay particles can be distributed efficiently and more evenly throughout the polymer matrix are highly desirable.

Another problem with forming filled polymers of macrocyclic oligomers is one of obtaining a sufficient conversion of oligomer to polymer within a commercially reasonable reaction period. This problem is seen especially in so-called reactive extrusion processes, in which the oligomer is both polymerized and mixed with other materials (such as fillers and catalysts) in an extruder. It is very difficult to obtain good mixing of the filler with the oligomer on the one hand, and at the same time obtain good conversion of oligomer to polymer, unless very slow throughput rates are used. At higher operating rates, conversions of oligomer to polymer are often so low that the extrudate cannot be used without further postcuring. This problem may be due in part to the formation of clay and/or clay modifier degradation products that interfere with the action of the polymerization catalyst. For whatever reason, it has proven very difficult to prepared filled polymers of macrocyclic oligomers in processes in which the macrocyclic oligomer is mixed with filler and polymerized in a single operation.

### SUMMARY OF THE INVENTION

In one aspect, this invention is a dispersion of filler particles in a macrocyclic oligomer, wherein the dispersion contains at least 15 weight percent dispersed filler particles.

In a second aspect, this invention is a composite of filler particles in a polymer or copolymer of a macrocyclic oligomer, wherein the composite contains at least 15 weight percent dispersed filler particles.

In a third aspect, this invention is a process for preparing a dispersion of filler particles in a polymer or polymerizable material, comprising

a) forming a masterbatch of filler particles dispersed in a macrocyclic oligomer, wherein the masterbatch contains at least 10 weight percent of dispersed filler particles, and

b) mixing the masterbatch with a polymer or polymerizable material to form a dispersion of the filler particles in a mixture of the macrocyclic oligomer and the polymer or polymerizable material.

In a fourth aspect, this invention is a process for preparing a nanocomposite of filler particles in a polymer of a macrocyclic oligomer, comprising

a) forming a masterbatch of a filler particles dispersed in a macrocyclic oligomer, wherein the masterbatch contains at least 15 weight percent of the filler particles, and

b) mixing the masterbatch with a polymer or polymerizable material to form a dispersion of the filler particles in a mixture of the macrocyclic oligomer and the polymer or polymerizable material, and

c) polymerizing the macrocyclic oligomer in the presence of the dispersed filler particles.

This process provides a method by which excellent dispersion of the filler particles into the polymer phase can be achieved. In the preferred cases where the filler particle is a layered material such as a clay, the excellent dispersion in turn allows for a higher degree of exfoliation of the clay within the polymer matrix, resulting in very efficient reinforcement and other desirable physical and thermal properties. The formation of a masterbatch having a high concentration of dispersed filler particles simplifies metering and mixing of components during reactive extrusion processes (and other melt processing operations), leading to a more uniform product and easier operation. Higher conversions of oligomer to polymer are often seen, particularly in reactive extrusion and other, similar melt processing operations in which the masterbatch is let down into another polymer or polymerizable material and polymerized in a single processing step.

### DETAILED DESCRIPTION OF THE INVENTION

The masterbatch of the invention contains 10%, preferably 15%, by weight or more of filler particles dispersed into a continuous phase that includes a macrocyclic oligomer. The weight of the filler particles is expressed herein in terms of the total weight of the masterbatch. The masterbatch may contain up to 65% or more dispersed filler particles, for example, from 20 to 60% by weight of dispersed filler particles, from 20 to 50% or from 25 to 50% by weight dispersed filler particles.

The filler particles may in principle be any particulate filler, but the advantages of the invention are especially seen when the filler is in the form of submicron-sized particles, or is a layered material that can be partially or fully exfoliated into sub-micron sized particles. Particles having a smallest dimension of about 0.6 nanometers or greater and preferably about 1 nanometer or greater, up to about 50 nanometers, more preferably up to about 20 nanometers, and especially up to about 10 nanometers. Particle sizes in this invention refer to volume average particle sizes of the dispersed filler particles, measured using an appropriate analytical method such as transmission electron microscopy, not simply to the as-received filler. The as-received filler may be in the form of aggregates, or may have a layered structure, which is often subdivided into smaller materials during the process of making the masterbatch and/or composite.

Preferably, the filler particles have an aspect ratio of about 10 or greater, more preferably about 100 or greater and most preferably about 500 or greater. “Aspect ratio” as used herein means the length of the largest dimension of a platelet or fiber divided by the smallest dimension, which is preferably the platelet or fiber thickness.

The balance of the weight of the masterbatch is constituted by at least one macrocyclic oligomer and optionally one or more other components, such as a polymerization catalyst, comonomer, chain extender, another polymer, an impact modifier or a rubber, as described more below. A masterbatch of particular interest includes macrocyclic oligomer and dispersed submicron-sized particles of a layered clay that are partially or fully exfoliated, but no other polymeric, polymerizable or reactive materials, impact modifiers or rubbers. Another masterbatch of particular interest includes dispersed submicron sized filler particles (in particular particles of a layered clay that are partially or fully exfoliated) macrocyclic oligomer and a polymerization catalyst, but no other polymeric, polymerizable or reactive materials, or impact modifiers or rubbers. Another masterbatch of particular interest includes dispersed particles of a layered clay that may be partially or fully exfoliated, dispersed conductive carbon filler particles, macrocyclic oligomer and a polymerization catalyst, but no other polymeric, polymerizable or reactive materials, or impact modifiers or rubbers. By “reactive materials”, it is meant a material that crosslinks, copolymerizes with or chain extends the polymerized macrocyclic oligomer.

The masterbatch of the invention is prepared by combining the filler particles, macrocyclic oligomer and any optional components, and mixing the materials to form a dispersion of the clay. This can be accomplished in a solventless, melt blending process, or via a diluent process. Shear may be and preferably is applied to the mixture of the clay and macrocyclic oligomer to further effect exfoliation of the clay. The timing of the shearing step can vary as discussed more fully below.

In one solventless process, the macrocyclic oligomer is blended with the filler particles at a temperature close to or above the melting temperature of the macrocyclic oligomer. In another solventless process, a dry blend of the macrocyclic oligomer and clay is formed, and then heated close to or above the melting temperature of the macrocyclic oligomer to allow the oligomer to soften or melt and the clay to become blended into the oligomer. In these solventless processes, optional components may be added in any convenient order. For example, optional components can be pre-blended with the macrocyclic oligomer before being added to the filler particles, or may be pre-blended with the filler particles before adding the macrocyclic oligomer. Optional components can be added separately to each of the filler particles and the macrocyclic oligomer.

There are several diluent-based approaches to preparing the masterbatch. In one such process, the filler particles and a diluent are combined and mixed to disperse the filler particles into the diluent. This is conveniently performed at any temperature at which the diluent is a liquid. A temperature of from about 0-50° C., especially from about 20-35° C., is generally suitable. The filler/diluent mixture is then agitated and/or sheared to achieve an initial dispersion of the filler particles into the diluent. Some intercalation and exfoliation of layered filler particles such as layered clay particles may occur during this dispersing step. If desired, this agitation or shearing can be performed until the filler particles form a non-settling, roughly homogenous dispersion in the diluent. The filler/diluent dispersion is then combined with macrocyclic oligomer. As the macrocyclic oligomer is typically a solid material at room temperature, it may alternatively be heated to above its melting temperature in order to blend it with the filler/diluent dispersion. This may be accomplished by melting the macrocyclic oligomer and combining the molten macrocyclic oligomer with the filler/diluent dispersion, taking care to maintain the temperature sufficiently high that the macrocyclic oligomer remains a liquid until the blending is completed. Alternatively, the macrocyclic oligomer may be added to the filler/diluent dispersion as a solid, preferably particulate, material, and the entire composition then heated if necessary to melt or dissolve the macrocyclic oligomer. In this approach, optional materials can be added at any convenient stage.

Raw materials (filler particles, diluent, macrocyclic oligomer and other optional components) that contain water or volatile impurities are preferably dried prior to forming the masterbatch.

Several alternative approaches to the foregoing diluent-based method can be used. In one alternative approach, the macrocyclic oligomer is dissolved into the diluent, and the filler particles are dispersed into the resulting macrocyclic oligomer solution. In another alternative approach, the filler, diluent and macrocyclic oligomer are all combined together, heated if necessary to a temperature sufficient to melt or dissolve the macrocyclic oligomer, and the resulting mixture agitated to disperse the filler particles.

In a third alternative approach, a dispersion of the filler particles in the diluent is formed, as is a separate solution of the macrocyclic oligomer in an additional quantity of the diluent, which in this variation is a solvent for the macrocyclic oligomer. The filler/diluent dispersion and the macrocyclic oligomer solution are blended and the resulting blend is mixed as before to disperse the filler particles. The macrocyclic oligomer solution can be added to the filler/diluent dispersion as a liquid, by first heating (if necessary) the solution above its melting temperature. Alternatively, if the macrocyclic oligomer solution is a solid at room temperature (˜22° C.), it can be dispersed as a particulate solid into the filler/diluent dispersion, and the resulting mixture heated to melt the macrocyclic oligomer solution and form the blend. This approach permits initial processing in a lower viscosity, lower temperature environment, and allows the filler dispersion and macrocyclic oligomer solution to be mixed in a relatively low temperature, low viscosity environment.

In any of the foregoing approaches, any material can be added to another continuously, intermittently or incrementally.

The diluent used in the foregoing diluent-based approaches is any material that is liquid at room temperature or some mildly elevated temperature (such as up to 50° C.), and which does not undesirably react with the filler particles or the macrocyclic oligomer. In preferred embodiment, in which the filler is or includes a layered clay, the diluent is preferably one which swells the clay. The diluent may be a solvent for the macrocyclic oligomer, but in many instances does not have to be. However, the preferred diluents are solvents for the macrocyclic oligomer at some temperature below the boiling temperature of the diluent. The diluent may be relatively high-boiling, for example, one having a boiling temperature of about 100 to about 300° C., especially from about 100 to about 200° C. However, lower-boiling diluents having a boiling temperature of below 100° C. are preferred when the diluent is to be removed prior to subsequent letting down and polymerization steps. The diluent should not be reactive with the macrocyclic oligomer, crosslinkers, co-monomers or modifiers that are present. Suitable diluents include halogenated (especially chlorinated) hydrocarbons such as methylene chloride, chloroform, orthodichlorobenzene, aromatic and/or alkyl-substituted aromatic hydrocarbons, and high boiling ethers, ketones, alcohols and esters.

The amount of diluent can range significantly to provide a desirable concentration of the macrocyclic oligomers (and any optional comonomers, crosslinkers or modifiers) in the solution. A suitable concentration of solvent is from about 1 to 95% of the combined weight of the solvent, macrocyclic oligomers, co-monomers, crosslinkers and modifiers. A more suitable concentration thereof is about 10-80% by weight. An especially suitable concentration is about 25-75% by weight.

In order to further disperse a layered clay, the clay/macrocyclic oligomer mixture is preferably subjected to shearing. “Shearing” refers to manipulation, which may be some mechanical process like agitation, stirring, compounding or mastication, or another process such as sonification, which mechanically separates at least some of the clay layers to form at least partially exfoliated clay platelets dispersed in the macrocyclic oligomer phase. When the filler particles are the preferred layered clay materials, this shearing step is often accompanied by an effect known as intercalation, in which the macrocyclic oligomer and/or diluent penetrate between the layers of the clay, and by exfoliation, or the separation of the clay particles into individual platelets. This is evidenced by an increase in the average interlayer spacing of at least some of the clay particles, generally by at least 2 angstroms, and more typically by at least 5 angstroms, compared to the original interlayer spacing of the clay. This can be determined by X-ray diffraction methods as well as transmission electron microscopy. X-ray diffraction patterns show changes such as a shift in the d-spacing, perhaps accompanied by a weakening or broadening of diffraction maxima associated with the interlayer distances, indicating that the interlayer distances are made less uniform during the intercalation and exfoliation processes. The intercalation and exfoliation of the clay particles improves the efficiency of the clay in providing reinforcement (resulting in physical property improvements) and in improving the thermal properties of the composite.

Shear can be applied at any stage of masterbatch preparation or use, although in general shear is applied at one or more stages during which the oligomer is molten or dissolved in the diluent. Thus, the filler/macrocyclic oligomer mixture can be subjected to shearing as or immediately after the filler and oligomer are combined, when the masterbatch is let down into the additional polymer or polymerizable material, or during the step of using the let-down masterbatch to make a molded or shaped article. When the masterbatch is made in a diluent-based process, it can be subjected to the shearing step before or after the diluent is removed.

The masterbatch is conveniently sheared during preparation using a high speed mixing blade, a single or twin-screw extruder, or other specialized mixing device that produces high shear. Shear rates of 10,000 reciprocal seconds or greater, such as 20,000-150,000 reciprocal seconds or from 30,000 to 100,000 reciprocal seconds are particularly useful. A variety of high shear mixing devices are useful. An example of a suitable high shear mixer is a serrated blade, commonly known as a Cowles blade, rotating so as to produce a tip speed of 2500 feet per minute or higher, such as from about 3000 to about 6000 feet per minute or about 3500 to about 5000 feet per minute. In the preferred embodiments, the shearing is continued for a time period of about 2 minutes or greater, more preferably about 10 minutes or greater and most preferably about 15 minutes or greater is generally sufficient. A period of no longer than about 90 minutes, such as about 40 minutes or less and most preferably about 25 minutes or less, is also generally sufficient. Excessive shearing times may cause the filler particles and/or the macrocyclic oligomer to degrade.

Shearing is conveniently applied during the let down step or in subsequent melt processing operations using an extruder, such as a twin screw extruder. Shear rates as described before are suitable. In this way, the shearing step can be performed at the same time the masterbatch is combined with additional polymer or polymerizable material, and/or at the same time the let-down dispersion is melt processed to form an article.

The shearing step is preferably done at a temperature at which the macrocyclic oligomer (and additional polymer or polymerizable oligomers as may be present) are fluids. Unless the shearing step is performed in the presence of a solvent or diluent, it will normally be necessary to conduct the shearing step at an elevated temperature. The temperature that is needed in any particular instance will of course depend on the particular macrocyclic oligomer, the presence of a solvent or diluent, if any, and if a solvent or diluent is present, the particular solvent or diluent and the relative proportions of solvent or diluent, macrocyclic oligomer and other polymers and/or polymerizable materials. A suitable temperature for conducting the shearing step is from about 100° C. to about 300° C., such as from about 100° C. to about 250° C. or about 100° C. to about 200° C., depending on the particular materials that are present.

Filler particles include, but are not limited to glass (including cloth, powders, microspheres and fibers); carbons and graphites including cloth, powders, platelets, fibers, and nanotubes; silicates including talc, feldspar, wollastonite and clays; hydroxides including alumina trihydrate and magnesium hydroxide; metals including powders, flake, fibers; ceramics including powders, platelets, whiskers and fibers; in addition to inorganic oxides, carbonates, sulfates, aluminates, aluminosilicates, stearates and borates. Filler particles can also include organic materials such as synthetic or natural polymer powders or fibers, cellulosic powders or fibers including wood, starch and cotton; as well as vegetable matter. Such fillers are used for replacing the more expensive polymer, for reinforcement and strengthening, for impact modification, for coloring, for improving the flammability resistance, for improving optical, electrical or magnetic properties, for mold release and various other improvements in cost, processability or performance. The filler particles may function as a colorant such a pigment, lake, or dyes, and/or may function as a catalyst, stabilizer or flame retardant.

Clays that are useful in this invention are minerals or synthetic materials having a layered structure, in which the individual layers are platelets or fibers with a thickness in the range of 5-100 angstroms. Suitable clays include kaolinite, halloysite, serpentine, montmorillonite, beidellite, nontronite, hectorite, stevensite, saponite, illite, kenyaite, magadiite, muscovite, sauconite, vermiculite, volkonskoite, pyrophylite, mica, chlorite or smectite. Preferably, the clay comprises a natural or synthetic clay of the kaolinite, mica, vermiculite, hormite, illite or smectite groups. Preferred kaolinite group clays include kaolinite, halloysite, dickite, nacrite and the like. Preferred smectite clays include montmorillonite, nontronite, beidellite, hectorite, saponite, bentonite and the like. Preferred minerals of the illite group include hydromicas, phengite, brammalite, glauconite, celadonite and the like. More preferably, the preferred layered minerals include those often referred to as 2:1 layered silicate minerals like muscovite, vermiculite, beidelite, saponite, hectorite and montmorillonite, wherein montmorillonite is most preferred. Preferred minerals of the hormite group include sepiolite and attapulgite, wherein the layered structure is interrupted in one dimension resulting in a fibrous or lath-like particle morphology.

In addition to the clays mentioned above, admixtures prepared therefrom may also be employed as well as accessory minerals including, for instance, quartz, biotite, limonite, hydrous micas, feldspar and the like. The layered minerals described above may be synthetically produced by a variety of processes, and are known as synthetic hectorites, saponites, montmorillonites, micas as well as their fluorinated analogs. Synthetic clays can be prepared via a number of methods which include the hydrolysis and hydration of silicates, gas solid reactions between talc and alkali fluorosilicates, high temperature melts of oxides and fluorides, hydrothermal reactions of fluorides and hydroxides, shale weathering as well as the action of acid clays, humus and inorganic acids on primary silicates.

The clay is preferably modified with an organic onium compound, such as described in U.S. Pat. No. 5,707,439 and PCT/US03/041,476. This modification is believe to result from a cation exchange reaction between the organic onium compound with the native clay, substituting the organic onium compound for mainly alkali metal and alkaline earth cations present in the unmodified clay. The onium compound is a salt comprising a negatively-charged counter-ion and a positively-charged nitrogen, phosphorus or sulfur atom. Particularly useful onium compounds have at least one ligand with a five carbon atom or greater chain. Preferably the onium compound has at least one ligand with a five carbon atom or greater chain and also contains at least one (and preferably two or more) other ligands containing a functional group having an active hydrogen atom that is capable of reacting with the macrocyclic oligomer during the polymerization reaction. The anion counterion in the onium compound can be any anion which forms a salt with an onium compound and which can be exchanged with an anionic species on the clay particle. Preferably the onium compound corresponds to the formula 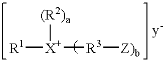
wherein R¹ is a C₅ or greater straight, alicyclic or branched chain hydrocarbyl group, R² is independently in each occurrence a C₁₋₂₀ hydrocarbyl group optionally containing one or more heteroatoms; R³ is a C₁₋₂₀ alkylene or cycloalkylene moiety; X is a nitrogen, phosphorus or sulfur atom; Z is an active hydrogen atom-containing functional group; a is separately in each occurrence an integer of 0, 1 or 2, y is an anion and b is an integer of 1 to 3 wherein the sum of a+b is 2 where X is sulfur and 3 where X is nitrogen or phosphorus. More preferably X is nitrogen. More preferably, R¹ is a C₁₀₋₂₀ hydrocarbon chain; and most preferably a C₁₂₋₁₈ alkyl group. More preferably, R² is C₁₋₁₀ hydrocarbyl and most preferably C₁₋₃ alkyl. More preferably, R³ is C₁₋₁₀ alkylene and most preferably C₁₋₃ alkylene. More preferably, Z is a primary or secondary amine, thiol, hydroxyl, acid chloride or carboxylic acid, carboxylate ester or glycidyl group; even more preferably a primary amine or hydroxyl group and most preferably a hydroxyl group. More preferably, y is separately in each occurrence a halogen or sulfate ester (such as an alkyl sulfate like methyl sulfate), and most preferably chlorine or bromine. More preferably, a is an integer of 0 or 1, and most preferably 1. Most preferably, b is 2 or 3.

Other onium compounds that do not contain the active-hydrogen containing functional group can be used instead of or in combination with those described above. Suitable examples of these include those described in U.S. Pat. No. 5,530,052 and U.S. Pat. No. 5,707,439, incorporated herein by reference. When such non-functional onium compounds are used, they are preferably used in combination with the functional types. The onium compounds containing functional groups tend to act as initiation sites for polymerization of the macrocyclic oligomers. The presence of these initiation sites tends to increase the number of polymer chains that are formed, which in turn tends to reduce average molecular weight of the polymer. Using a mixture of the functional and non-functional types permits one to balance molecular weight effects with good dispersion of the clay into the polymer matrix. Preferably, the functional onium compound constitutes at least 1 weight percent or greater, such as at least 10 weight percent or at least 20 weight percent, about 100 percent by weight, such as up to about 90 weight percent, up to about 50 weight percent or up to about 30 weight percent of all onium compounds used.

The onium compounds tend to enhance the ability of the catalyst and macrocyclic oligomer to intercalate the clay. Preferably, at least 50 percent, such as at least 75 percent or at least 90 percent of the exchangeable cations on the clay are replaced with the onium compound. An excess of the onium compound, such as up to 1.5 equivalents or 1.25 equivalents of onium compound per equivalent of exchangeable cations, may be used.

The macrocyclic oligomer is a polymerizable cyclic material having two or more ester linkages in a ring structure. The ring structure containing the ester linkages includes at least 8 atoms that are bonded together to form the ring. The oligomer includes two or more structural repeat units that are connected through the ester linkages. The structural repeat units may be the same or different. The number of repeat units in the oligomer suitable ranges from about 2 to about 8. Commonly, the cyclic oligomer will include a mixture of materials having varying numbers of repeat units. A preferred class of cyclic oligomers is represented by the structure
—[O—A—O—C(O)—B—C(O)]_{y}— (I)
where A is a divalent alkyl, divalent cycloalkyl or divalent mono- or polyoxyalkylene group having two or more carbon atoms, B is a divalent aromatic or divalent alicyclic group, and y is a number from 2 to 8. The bonds indicated at the ends of structure I connect to form a ring. Examples of suitable macrocyclic oligomers corresponding to structure I include oligomers of 1,4-butylene terephthalate, 1,3-propylene terephthalate, 1,4-cyclohexenedimethylene terephthalate, ethylene terephthalate, and 1,2-ethylene-2,6-naphthalenedicarboxylate, and copolyester oligomers comprising two or more of these. The macrocyclic oligomer is preferably one having a melting temperature of below about 200° C. and preferably in the range of about 150-190° C. A particularly preferred cyclic oligomer is an oligomer of 1,4-butylene terephthalate.

Suitable methods of preparing the cyclic oligomer are described in U.S. Pat. Nos. 5,039,783, 6,369,157 and 6,525,164, WO 02/18476 and WO 03/031059, all incorporated herein by reference. In general, cyclic oligomers are suitably prepared in the reaction of a diol with a diacid, diacid chloride or diester, or by depolymerization of a linear polyester. The method of preparing the cyclic oligomer is generally not critical to this invention.

The masterbatch may include one or more polymerization catalysts for the macrocyclic oligomer and/or other polymerizable materials that are either present in the masterbatch or which will be subsequently blended with the masterbatch. Enough catalyst is preferably included so that an effective amount of catalyst is present after the masterbatch is let down. A typical amount of catalyst is from 0.25 to about 5 percent of the weight of the masterbatch. Tin- or titanate-based polymerization catalysts are of particular interest. Examples of such catalysts are described in U.S. Pat. No. 5,498,651 and U.S. Pat. No. 5,547,984, the disclosures of which are incorporated herein by reference. One or more catalysts may be used together or sequentially.

Illustrative examples of classes of tin compounds that may be used in the invention include monoalkyltin hydroxide oxides, monoalkyltinchloride dihydroxides, dialkyltin oxides, bistrialkyltin oxides, monoalkyltin trisalkoxides, dialkyltin dialkoxides, trialkyltin alkoxides, tin compounds having the formula 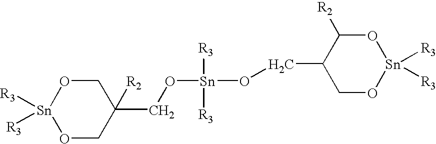
and tin compounds having the formula 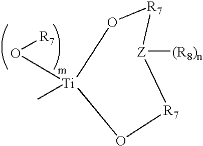
wherein R₂ is a C₁₋₄ primary alkyl group, and R₃ is C₁₋₁₀ alkyl group. Specific examples of organotin compounds that may be used in this invention include 1,1,6,6-tetra-n-butyl-1,6-distanna-2,5,7-10-tetraoxacyclodecane, n-butyltinchloride dihydroxide, di-n-butyltin oxide, di-n-octyltin oxide, n-butyltin tri-n-butoxide, di-n-butyltin di-n-butoxide, 2,2-di-n-butyl-2-stanna-1,3-dioxacycloheptane, and tributyltin ethoxide. In addition, tin catalysts described in U.S. Pat. No. 6,420,047 (incorporated by reference) may be used in the polymerization reaction.

Titanate compounds that may be used in the invention include those described in U.S. Pat. No. 6,420,047 (incorporated by reference). Illustrative examples include tetraalkyl titanates (e.g., tetra(2-ethylhexyl) titanate, tetraisopropyl titanate, and tetrabutyl titanate), isopropyl titanate, titanate tetraalkoxide. Other illustrative examples include (a) titanate compounds having the formula 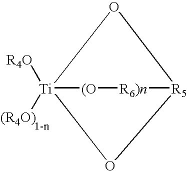
wherein each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1, (b) titanate ester compounds having at least one moiety of the formula 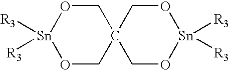
wherein each R₇ is independently a C₂₋₃ alkylene group; Z is O or N; R₈ is a C₁₋₆ alkyl group or unsubstituted or substituted phenyl group; provided when Z is O, m−n−0, and when Z is N, m=0 or 1 and m+n=1, and (c) titanate ester compounds having at least one moiety of the formula 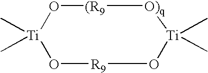
wherein each R₉ is independently a C₂₋₆ alkylene group; and q is 0 or 1.

Suitable polymerization catalysts can be represented as
RₙQ₍₃₋ₙ₎Sn—O—X (II)
where n is 1 or 2, each R is independently an inertly substituted hydrocarbyl group, Q is an anionic ligand, and X is a moiety having a tin, zinc, aluminum or titanium atom bonded directed to the adjacent oxygen atom. Suitable X groups include —SnRₙQ₍₃₋ₙ₎, where R, Q and n are as described before; —ZnQ, where Q is as described before, —Ti(Q)₃, where Q is as described before, and —AlRₚ(Q)₍₂₋ₚ₎, where R is as described before and p is zero, 1 or 2. Preferred Q groups include —OR groups, where R is as described above. When X is SnRₙQ₍₃₋ₙ₎, R and/or OR groups may be divalent radicals that form ring structures including one or more of the tin or other metal atoms in the catalyst. Preferred X moieties are —SnRₙQ₍₃₋ₙ₎, —Ti(OR)₃ and —AlRₚ(OR)₍₂₋ₚ₎. —SnRₙQ₍₃₋ₙ₎ is a particularly preferred type of X moiety. Preferred X groups are —SnRₙQ₍₃₋ₙ₎, —Ti(OR)₃ and —AlRₚ(OR)₍₂₋ₚ₎. n is preferably 2. These catalysts are described in more detail in U.S. Provisional Application No. 60/564,552, filed Apr. 22, 2004. Examples of particular polymerization catalysts of this type include 1,3-dichloro-1,1,3,3-tetrabutyldistannoxane; 1,3-dibromo-1,1,3,3-tetrabutyldistannoxane; 1,3-difloro-1,1,3,3-tetrabutyldistannoxane; 1,3-diacetyl-1,1,3,3-tetrabutyldistannoxane; 1-chloro-3-methoxy-1,1,3,3-tetrabutyldistannoxane; 1,3-methoxy-1,1,3,3-tetrabutyl distannoxane; 1,3-ethoxy-1,1,3,3-tetrabutyldistannoxane; 1,3-(1,2-glycolate)-1,1,3,3-tetrabutyldistannoxane; 1,3-dichloro-1,1,3,3-tetraphenyldistannoxane; (n-butyl)₂(ethoxy)Sn—O—Al(ethoxide)₂, (n-butyl)₂(methoxy)Sn—O—Zn(methoxide), (n-butyl)₂(i-propoxy)Sn—O—Ti(i-propoxide)₃, (n-butyl)₃Sn—O—Al(ethyl)₂, (t-butyl)₂(ethoxy)Sn—O—Al(ethoxide)₂, and the like. Suitable distannoxane catalysts are described in U.S. Pat. No. 6,350,850, incorporated herein by reference.

A copolymerizable monomer may be incorporated into the masterbatch. The copolymerizable monomer is a material other than a macrocyclic oligomer that will copolymerize with the macrocyclic oligomer to form a random or block copolymer. Suitable copolymerizable monomers include cyclic esters such as lactones. The lactone conveniently contains a 4-7 member ring containing one or more ester linkages. The lactone may be substituted or unsubstituted. Suitable substituent groups include halogen, alkyl, aryl, alkoxyl, cyano, ether, sulfide or tertiary amine groups. Substituent groups preferably are not reactive with an ester group in such a way that they cause the copolymerizable monomer to function as an initiator compound. Examples of such copolymerizable monomers include glycolide, dioxanone, 1,4-dioxane-2,3-dione, ε-caprolactone, tetramethyl glycolide, β-butyrolactone, lactide, γ-butyrolactone and pivalolactone.

Another optional material that may be included in the masterbatch is a polyfunctional chain extending compound having two or more functional groups which will react with functional groups on the polymerized macrocyclic oligomer (and/or another polymer in the blend). Examples of suitable functional groups are epoxy, isocyanate, ester, hydroxyl, carboxylic acid, carboxylic acid anhydride or carboxylic acid halide groups. More preferably, the functional groups are isocyanate or epoxy, with epoxy functional groups being most preferred. Preferred epoxy-containing chain extenders are aliphatic or aromatic glycidyl ethers. Preferred isocyanate-containing chain extenders include both aromatic and aliphatic diisocyanates. Preferably, the chain extender has about 2 to about 4, more preferably about 2 to about 3 and most preferably about 2 such functional groups per molecule, on average. The chain extender material suitably has an equivalent weight per functional group of 500 or less. A suitable amount of chain extender provides, for example, at least 0.25 mole of functional groups per mole of reactive groups in the polymerized macrocyclic oligomer.

The masterbatch may also include one or more polymeric materials which will form a polymer blend with the polymerized macrocyclic oligomer during its subsequent polymerization. Examples of such polymeric materials include, for example, polyesters such as poly(•-caprolactam), polybutylene terephthalate, polyethylene adipate, polyethylene terephthalate and the like, polyamides, polycarbonates, polyurethanes, polyether polyols, polyester polyols, and amine-functional polyethers and/polyesters. Polyolefins (such as polymers and interpolymers of ethylene, propylene, a butylene isomer and/or other polymerizable alkenes) that contain functional groups that react with functional groups on the polymerized macrocyclic oligomer and/or a chain extending agent can be used. Other polymeric materials that are compatible with the macrocyclic oligomer and/or the polymerized macrocyclic oligomer or contain functional groups that permit them to be coupled to the polymerized macrocyclic oligomer are also useful. Certain of these polymers may engage in transesterification reactions with the macrocyclic oligomer or its polymer during the polymerization process, to form block copolymers. Polymeric materials having reactive functional groups may be coupled to the polymerized macrocyclic oligomer with chain extenders as described above. Suitable functionalized polymeric materials contain about 1 or more, more preferably about 2 to about 3 and most preferably about 2 such functional groups per molecule, on average, and have an equivalent weight per functional group of greater than 500. Their molecular weights are suitably up to about 100,000, such as up to about 20,000 or up to about 10,000. Preferably, the polymeric material has a glass transition temperature significantly lower (such at least 10° C. lower or at least 30° C. lower) than the glass transition temperature of the polymerized macrocyclic oligomer alone. The lower glass transition temperature polymeric materials tend to improve the ductility and impact resistance of the resulting product. The functionalized polymer can contain any backbone which achieves the desired results of this invention. An especially suitable polyfunctional polymer is a polyether or polyester polyol.

Another optional component of the masterbatch is an impact modifier. Any impact modifier which improves the impact properties and toughness of the polymer composition may be used. Examples of impact modifiers include core shell modifiers, olefinic toughening agents, block copolymers of monovinylidene aromatic compounds and alkadienes and ethylene-propylene diene monomer based polymers. The impact modifiers can be unfunctionalized or functionalized with polar functional groups. Suitable core shell rubbers include functionalized core shell rubbers having surface functional groups that react with the macrocyclic oligomer or functional groups on the polymerized macrocyclic oligomers. Preferred functional groups are glycidyl ether moieties or glycidyl acrylate moieties. The core-shell rubber will generally contain about 30 to about 90 percent by weight core, where “core” refers to the central, elastomeric portion of the core shell rubber. The core-shell modifier may be added after the polymerization is complete, in a high shear environment such as an extruder.

A natural or synthetic rubber is another type of modifier that is useful and may be added to the composition. Rubber is generally added to improve the toughness of the polymer. Rubber modified polymers desirably exhibit a dart impact strength (according to ASTM D3763-99) of about 50 inch/lbs (5.65 N-m) or greater, more preferably about 150 inch/lbs (16.95 N-m) or greater and most preferably about 300 inch/lbs (33.9 N-m) or greater.

When one or more of these optional materials (catalyst, chain extender, additional polymer, impact modifier or rubber) is present in the masterbatch, the macrocyclic oligomer preferably constitutes from about 25-85% of the weight of the masterbatch, for example from 40-80% or from 50-75% of the weight of the masterbatch.

The masterbatch is in most instances a solid material at room temperature. It may be ground or pelletized to facilitate being let down with additional macrocyclic monomer or other materials.

A clay-reinforced polymer nanocomposite is formed by letting down the masterbatch into a polymer or polymerizable material, and polymerizing the macrocyclic oligomer (and other polymerizable materials, if any). Any melt-processable polymer can be used to let down the masterbatch, including, for example, a polymer of the macrocyclic oligomer or another macrocyclic oligomer, a polymer that is compatible with the polymerized macrocyclic oligomer, a polymer that is reactive with the macrocyclic oligomer or its polymer (such as one that forms a random or block copolymer therewith, or contains functional groups that react with the macrocyclic oligomer or its polymer), or even a polymer that is relatively incompatible with the macrocyclic oligomer or its polymer (to form a phase-segregated blend or alloy). Examples of suitable polymers include polyolefins, polyesters, polyethers, polyurethanes, polyacrylates, poly(vinyl aromatics), poly(vinyl alcohols), polyamides, styrene-butadiene copolymers, and the like. Suitable polymerizable materials include additional quantities of the macrocyclic oligomer, a different macrocyclic oligomer, a monomer other than a macrocyclic oligomer that can form random or block copolymers with the macrocyclic oligomer, or other polymerizable material.

Let-down ratios are selected so that the desired level of dispersed filler particles is present in the final product. This level is generally from about 1 to about 30, especially from about 2-20, and more preferably from about 2-8% filler particles by weight. To accomplish this, a let-down weight ratio of from about 0.5-20 parts of additional polymer or polymerizable material to 1 part masterbatch, especially about 1-10:1 and more preferably about 2-6:1 is often convenient. This is conveniently done by melting the components and mixing them, or by forming a dry blend followed by heating and mixing. As mentioned before, the mixing step may be accompanied or followed by a shearing step to disperse the filler and/or promote the exfoliation of the clay. Particulate starting materials may be dry blended ahead of time. An advantage of the invention is that metering of components is simplified, thus helping improve the consistency of the composition of the blended product. Mixing is also improved, resulting in a more uniform product and better dispersion and exfoliation of layered clay particles.

If a diluent-based method is used to make the masterbatch, the diluent is conveniently removed, either before or after it is let down. Conventional methods of decanting, drying, distillation, vacuum distillation, filtration, extraction or combinations of these can be used. Drying and distillation methods, especially vacuum drying and vacuum distillation methods, are suitable when the diluent has a relatively low boiling temperature. Extraction methods are of particular interest when the diluent is higher-boiling. Extraction methods can be performed on the masterbatch or let-down masterbatch by contacting it with an extractant in which the diluent is miscible. The extractant is generally a volatile hydrocarbon, halocarbon or alcohol having a boiling temperature of below 100° C. The greater volatility of the extractant allows residual quantities of the extractant to be removed from the dispersion by exposing it to vacuum and/or moderately elevated temperatures, for example, within a devolatilizing extruder.

In one aspect of the invention, the macrocyclic oligomer is polymerized after the masterbatch is let down. Methods of polymerizing cyclic oligomers are well known. Examples of such methods are described in U.S. Pat. Nos. 6,369,157 and 6,420,048, WO 03/080705, and U.S. Published Application 2004/0011992, among many others. Any of these conventional polymerization methods are suitable for use with this invention. In general, the polymerization reaction is conducted in a presence of a polymerization catalyst as described before.

The polymerization is conducted by heating the dispersion above the melting temperature of the macrocyclic oligomer in the presence of the polymerization catalyst. The polymerizing mixture is maintained at the elevated temperature until the desired molecular weight and conversion are obtained. Suitable polymerization temperatures are from about 100° C. to about 300° C., with a temperature range of about 100° C. to about 280° C. being preferable and a temperature range of about 180-270° C. being especially preferred.

The catalyst is preferably incorporated into the masterbatch, but if not, it can be added during the polymerization or just prior to the polymerization. Enough catalyst is provided to provide a desirable polymerization rate and to obtain the desired conversion of oligomers to polymer, but it is usually desirable to avoid using excessive amounts of a catalyst. A suitable mole ratio of transesterification catalyst to macrocyclic oligomer can range from about 0.01 mole percent or greater, more preferably from about 0.1 mole percent or greater and more preferably 0.2 mole percent or greater. The mole ratio of transesterification catalyst to macrocyclic oligomer is from about 10 mole percent or less, more preferably 2 mole percent or less, even more preferably about 1 mole percent or less and most preferably 0.6 mole percent or less.

The polymerization may be conducted in a closed mold to form a molded article. An advantage of cyclic oligomer polymerization processes is that they allow thermoplastic resin molding operations to be conducted using techniques that are generally applicable to thermosetting resins. When melted, the cyclic oligomer typically has a relatively low viscosity. This allows the cyclic oligomer to be used in reactive molding process such as liquid resin molding, reaction injection molding and resin transfer molding, as well as in processes such as resin film infusion, impregnation of fiber mats or fabrics, prepreg formation, pultrusion and filament winding that require the resin to penetrate between individual fibers of fiber bundles to form structural composites. Certain processes of these types are described in U.S. Pat. No. 6,420,047, incorporated herein by reference.

The resulting polymer must achieve a temperature below its crystallization temperature before it is demolded. Thus, it may be necessary to cool the polymer before demolding (or otherwise completing processing). In some instances, particularly in polymerizing cyclic butylene terephthalate oligomers, the melting and polymerization temperature of the oligomers are below the crystallization temperature of the resulting polymer. In such a case, the polymerization temperature is advantageously between the melting temperature of the oligomer and the crystallization temperature of the polymer. This allows the polymer to crystallize at the polymerization temperature (isothermal curing) as molecular weight increases. In such cases, it is not necessary to cool the polymer before demolding can occur.

The polymerization can also be conducted as a bulk polymerization to produce a particulate polymer (such as a pelletized polymer) that is useful for subsequent melt processing operations, such as extrusion, injection molding, compression molding, thermoforming, blow molding, resin transfer molding and the like.

It is also possible to conduct a solution polymerization, letting the masterbatch down by combining it with a macrocyclic oligomer and a solvent for the macrocyclic oligomer. If the masterbatch is prepared in a diluent-based method using a diluent that is a solvent for the macrocyclic oligomer, that diluent can serve as the solvent for the solution polymerization. A solution polymerization is generally performed in bulk, to form a particulate or pelletized polymer that is useful for subsequent melt processing operations as described before. An advantage of the solution polymerization process is that lower temperatures are usually needed to melt the macrocyclic oligomer solution and thus conduct the polymerization. The lower temperatures reduce filler (in particular, clay) and macrocyclic monomer degradation and reduce energy requirements. The solution polymerization is suitably conducted at somewhat lower temperatures than a solventless polymerization, and at a temperature below the boiling temperature of the solvent. Suitable solution polymerization temperatures are from 100-270° C., especially from 150-220° C. Suitable solvents include those diluents described above which are solvents for the macrocyclic oligomer and have a boiling temperature at or below the polymerization temperature. The solvent can be removed from the resulting polymer using methods as described before, with an extraction method being particularly suitable. After solvent removal, the polymer is suitable for use in various melt-processing procedures to make molded or shaped articles.

The resulting composites may be further processed to increase molecular weight. Two approaches to accomplishing this are solid state polymerization and chain extension. Solid state polymerization is achieved by postcuring the composite by exposing it to an elevated temperature. This may be done during melt-processing operations or in a subsequent step. A suitable postcuring temperature is from about 170° C., about 180° C., or about 195° C. up to about 220° C., about 210° C. or about 205° C., but below the melting temperature of the polymer phase of the composite. The solid state polymerization is preferably performed in a non-oxidizing environment such as under a nitrogen or argon atmosphere and is preferably performed under vacuum and/or flowing to remove volatile components. Postcuring time times of about 1-36 hours, such as from 4-30 hours or 12-24 hours, are generally suitable. Preferably, the macrocyclic oligomer is advanced to a weight average molecular weight of about 60,000 or greater, more preferably about 80,000 or greater and most preferably about 100,000 or greater. It is usually not necessary to use additional catalyst to obtain solid state advancement.

Chain extension is performed by contacting the composite with a polyfunctional chain extending agent. The polyfunctional chain extending agent contains two or more functional groups that react with functional groups on the polymerized macrocyclic oligomer, to couple polymer chains and thus increase molecular weight. Suitable such polyfunctional chain extending agents are described above. No additional catalyst is usually required and elevated temperatures as described hereinbefore are used for the chain extension reaction.

In addition to the previously-described chain extenders and modifiers, various kinds of optional materials may be incorporated into the polymerization process. Examples of such materials include reinforcing agents (such as glass, carbon black or other fibers), flame retardants, colorants, antioxidants, preservatives, mold release agents, lubricants, UV stabilizers, and the like.

The masterbatch may be polymerized to form a low or high molecular weight polymer dispersion before being let down. This may be beneficial, for example, by increasing the viscosity of the molten masterbatch somewhat so it more closely matches that of another polymeric material, impact modifier or rubber, so that the materials are more easily and efficiently blended together during the let-down process. The masterbatch may be polymerized to form a polymerized macrocyclic oligomer having a weight average molecular weight of, for example, about 2000-20,000, or about 3000-10,000, prior to letting it down. Alternately, the masterbatch may be polymerized to a molecular weight of above 20,000, such as from 30,000-150,000, prior to letting it down. The polymerized masterbatch can be let down into more of the macrocyclic oligomer, another polymer or other polymerizable material, in the same way as described before.

The following examples are provided to illustrate the invention, but are not intended to limit the scope thereof. All parts and percentages are by weight unless otherwise indicated.

### EXAMPLES 1-3

430 parts of cyclic butylene terephthalate oligomers and 25 g of a cocoalkyl, methyl, bishydroxyethyl ammonium modified fluoromica clay (commercially available as Somasif™ MEE clay from Co-op Chemical) are charged to a flask equipped with a stirrer and gas adapter. The flask and its contents are heated under vacuum to 190° C. for one hour with gentle stirring, to dry the clay and oligomers. The mixture is then transferred to a baffled kettle equipped with a Cowles blade and heated to 190° C. with stirring at 3000 rpm. Another 920 parts of cyclic butylene terephthalate oligomers and 213 parts of the clay are gradually added to the kettle over 30 minutes, while maintaining the temperature near 190° C. during each addition. The total mixing time is 60 minutes. The resulting masterbatch material is poured into pans and placed in dry ice to rapidly solidify it. The solidified masterbatch material (Example 1) is then ground in a Wiley mill and dried overnight at 60° C. under vacuum. It contains about 15 weight percent clay.

Masterbatch Example 2 is made in the same manner, with the Somasif MEE clay being replaced with an equal weight of an inorganic, unmodified fluoromica clay (commercially available as Somasif™ ME-100 from Co-op Chemical).

Masterbatch Example 3 is made by charging 430 parts of cyclic butylene terephthalate oligomers and 25 g of the Somasif MEE clay to a flask equipped with a stirrer and gas adapter. The flask and its contents are heated under vacuum to 190° C. for one hour with gentle stirring, to dry the clay and oligomers. The mixture is then transferred to a baffled kettle equipped with a Cowles blade and heated to 190° C. with stirring at 3000 rpm. Another 920 parts of cyclic butylene terephthalate oligomers and 213 parts of the clay are gradually added to the kettle over 30 minutes, while maintaining the temperature near 190° C. during each addition. The mixture is heated for an additional hour at 190° C. following the addition of all ingredients. It is then cooled to 145° C., and 16.99 parts of 1,1,6,6-tetrabutyl-1,6-distanna-2,5,7,10-tetraoxacyclodecane (polymerization catalyst) are added and allowed to mix for one minute. The resulting masterbatch material is poured into pans and placed in dry ice to rapidly cool it to prevent premature polymerization and to solidify the material. The solidified masterbatch material is then ground in a Wiley mill and dried overnight at 60° C. under vacuum. It contains about 15 weight percent clay and 1.06 weight percent of the polymerization catalyst.

### EXAMPLE 4

A powdered cyclic butylene terephthalate oligomer is dry blended with masterbatch Example 1 at a 2:1 weight ratio and dried overnight at 90° C. under vacuum. The mixture is extruded in a Krupp-Werner Pfliederer Model ZSK-25 fully intermeshing co-rotating twin screw extruder, having a L/D ratio of 60 as a two-hole, 3-mm strand die. The mixture is starve-fed into the extruder using a screw-type powder feeder. The extrudate is water-cooled and palletized. The extruder is operated at 60 to 125 rpm, and the temperature profile is increased from 50° C. in the initial section to 240° C. over the latter sections of the extruder. Pellets produced in this manner are then subjected to solid state advancement in a vacuum oven at 200° C. for 8 hours. The resulting polymer is designated Example 4A.

Examples 4B and 4C are prepared in the same way, substituting masterbatch Examples 2 and 3, respectively, for the masterbatch used to make Example 4A.

Test bars are molded from the three compositions and also from a commercially available poly(butylene terephthalate) resin (Valox 315, from General Electric Corp.) using a 28 ton Arburg injection molding press, operated at 256° F. (124° C.) nozzle temperature and 205° F. (96° C.) mold temperature. The physical and thermal properties are as reported in Table 1.

TABLE 1

| | Tensile | | |
|---|---|---|---|
| Example | Modulus, | CLTE, | DTUL, ° F. |
| No. | psi (GPa) | cm/cm/° C. ×10⁻⁶ | (° C.) |
| Valox 315* | 357,000 (2.46) | 117 | 286 (141) |
| 4A | 571,000 (3.94) | 75 | 346 (174) |
| 4B | 459,000 (3.16) | 108 | 327 (164) |
| 4C | Not measured | 76 | 340 (171) |

*Not an example of the invention.

### EXAMPLE 5

Somasif™ MEE clay (181.4 g), cyclic butylene terephthalate oligomers (714.34 g) and butyltin chloride dihydroxide (11.4 g) are combined with about 2 liters of methylene chloride. The mixture is stirred at room temperature for 6 hours, and transferred to a rotoevaporator to remove the majority of the solvent. A gelled mixture is obtained, from which the remaining solvent is removed by drying in a vacuum oven at 80° C. The resulting masterbatch product is a solid containing ˜20% by weight dispersed clay and 1.3% by weight of the catalyst. The masterbatch is ground to a fine powder.

The masterbatch is let down with additional cyclic butylene terephthalate oligomers at a 1:3 weight ratio by blending the powdered materials, to make a polymerizable mixture containing about 5% by weight clay, and subsequently polymerized in a reactive extrusion process to form a composite of the clay in the polymerized poly(butylene terephthalate). The REX process equipment consists of a co-rotating twin screw extruder (Werner Pfleiderer and Krupp, 25 mm, 38 L/D) equipped with a gear pump, a 1″ (2.5 cm) static mixer (Kenics), a 2.5″ (6.25 cm) filter (80/325/80 mesh) and a two hole die downstream. The extruder is run at 10 pounds (4.54 kg)/hour and at barrel temperatures of 265° C. PET and advanced concentrate are separately fed into the feed throat of the extruder using vibratory feeders. The feeders and hopper are padded with inert gas during operation. All materials are dried in a vacuum oven at 90° C. for at least 8 hours before processing.

The 20% masterbatch is polymerized by advancement in a vacuum oven at 190° C. for 8 hrs. At the end of 8 hrs, the cyclic butylene terephthalate oligomer is 97% converted into poly(butylene terephthalate) with a weight average molecular weight of 41,600 (measured by GPC, relative to polystyrene standard). The advanced 20% concentrate is let down into poly(ethylene terephthalate) (PET, Grade XZM94A) at a 4 parts PET to 1 part masterbatch to yield a composition consisting of 80% PET, 16% PBT and 4% clay (Example 5). The pellets are injection molded into tensile bars. A similar composition is also prepared by mixing PET, PBT and Somasif MEE and extruding through the REX process described above (Comparative Sample B). A control sample (Comparative Sample A) is an unfilled 83/17 by weight blend of poly(ethylene terephthalate) and poly(butylene terephthalate).

The properties are as reported in Table 2 below.

TABLE 2

| | Tensile Modulus, |
|---|---|
| Example No. | psi (GPa) |
| Comp. Sample A* | 435,000 (3.00) |
| Comp. Sample B* | ** |
| 5 | 583,000 (4.02) |

*Not an example of this invention.
** Sample cannot be molded into tensile bars because of low conversion of oligomer to polymer.

The addition of 17% PBT into PET does not impact the tensile modulus significantly (Comparative Sample A). Differential scanning calorimetry (DSC) data shows a single melting and glass transition for each of Example 5 and Comparative Samples A and B, indicating a miscible system is formed via transesterification reactions in each case. Example 5 shows a 34% improvement in modulus relative to sample Comparative Sample A, which is unfilled. Comparative Sample B illustrates a common problem with the direct incorporation of filler into the oligomer during a reactive extrusion process. Conversion of oligomer to polymer suffers greatly, leading to the formation of a product that cannot even be molded into test specimens unless subjected to further curing. Sample 5 demonstrates that the problem of low conversion is overcome via the masterbatch approach to forming the composite.

### EXAMPLES 6 AND 7

A powder mixture of Somasif™ MEE clay, 1,1,6,6-tetra-n-butyl-1,6-distanna-2,5,7-10-tetraoxacyclodecane and cyclic butylene terephthalate oligomer in a weight ratio of 15:85:0.34 is dry blended and treated in a vacuum oven overnight at 80° C. A masterbatch of this composition is prepared by feeding the powder mixture into an 18 mm Leistritz co-rotating twin screw extruder operated at 170° C. at 5 lbs (2.27 kg)/hour. The melted extrudates are solidified, granulated and crystallized. X-ray diffraction shows that the masterbatches contain oligomer-intercalated clay, as evidenced by an increase in the interlayer spacing of the clay in the masterbatch vs. the initial value in the clay.

Example 7 is prepared as above, except the clay concentration is increased three-fold. X-ray diffraction results are similar to those for Example 6.

### EXAMPLES 8-10

Compositions are prepared from masterbatch Example 6 by a reactive extrusion process. The reaction extrusion process is run on a co-rotating twin screw extruder as described in Example 5. The extruder is run at 10 pounds (4.54 kg)/hour with an average residence time of 7.5 minutes. Granulated masterbatches and a cyclic butylene terephthalate/distannoxane catalyst mixture are dried in a vacuum oven at 90° C. for at least 8 hours before using. These are separately fed into the feed throat of the extruder using vibratory feeders. The feeders and hopper are padded with inert gas during operation. Mixing ratios are 1 part of masterbatch per 2 parts macrocyclic oligomer and 0.0067 parts catalyst. The extruder is operated at 120° C. in the initial zones, with downstream zones at 170° C. and the additional downstream equipment at 250° C. The stranded polymer extruded from the die is air cooled and chopped in a pelletizer. The extruded pellets are then solid state advanced in a vacuum oven for 8 hours at 200° C. Test bars are molded using a 28 ton Arburg press, using a 260° C. barrel temperature and 88° C. mold temperature. Mechanical and thermal properties of the resulting moldings (Example 8) are acquired using standard testing methods and are as tabulated in Table 2.

Polymer Example 9 is made in the same manner as Example 8, except the masterbatch of Example 6 is let down into cyclic butylene terephthalate oligomer and butyltinchloride dihydroxide is used as the polymerization catalyst. Results are as given in Table 2.

Polymer Example 10 is prepared in the same manner as Example 8, except that masterbatch Example 7 is let down into cyclic butylene terephthalate oligomer without added catalyst. Results are as indicated in Table 3.

TABLE 3

| | Tensile | CLTE, |
|---|---|---|
| | Modulus, psi | cm/cm/° C. |
| Example No. | (GPa) | ×10⁻⁶ |
| 8 | 489,000 (3.37) | 84 |
| 9 | 501,000 (3.45) | 79 |
| 10 | 488,000 (3.36) | 85 |
| Comp. Sample C* | 357,000 (2.42) | 117 |

*Not an example of the invention. This material is a commercially available, unfilled poly(butylene terephthalate.

Examples 8-10 further show very substantial improvements in tensile modulus, compared to the unfilled Comparative Sample C, with little adverse affect on CLTE.

### EXAMPLE 11

A cyclic butylene terephthalate masterbatch containing 15% by weight Somasif MEE clay is prepared in the general manner described in Example 4. This masterbatch is let down in a 1:2 ratio with additional cyclic butylenes terephthalate in the matter described in Example 5. The product (Example 11) has a weight average molecular weight of 46,000. There is a 95% conversion of oligomer to monomer. As a result, the product is easily formed into pellets or molded into shaped articles.

Comparative Sample D is prepared by directly mixing 5% Somasif MEE clay into cyclic butylenes terephthalate in the reactive extrusion process described in Example 5. Weight average molecular weight of the product is similar to that of Example 11, but conversion is only 73%. The polymer cannot be pelletized or molded due to the low conversion of oligomer to polymer.

It will be appreciated that many modifications can be made to the invention as described herein without departing from the spirit of the invention, the scope of which is defined by the appended claims.

What is claimed is:

1. A dispersion of filler particles in a macrocyclic oligomer, wherein the dispersion contains at least 15 weight percent dispersed filler particles.

2. The dispersion of claim 1, wherein the filler particles have a volume average smallest dimension of about 0.6 nanometer to about 50 nanometers.

3. The dispersion of claim 2, wherein the filler particles include a layered clay.

4. The dispersion of claim 2, which contains from 15 to 60% by weight dispersed filler particles.

5. The dispersion of claim 3, wherein the filler particles have a volume average smallest dimension of up to about 20 nanometers.

6. The dispersion of claim 3, wherein the macrocyclic oligomer is an oligomer of 1,4-butylene terephthalate, 1,3-propylene terephthalate 1,4-cyclohexenedimethylene terephthalate, ethylene terephthalate, and 1,2-ethylene-2,6-naphthalenedicarboxylate, or an oligomer of two or more thereof.

7. The dispersion of claim 6, wherein the dispersion further contains a diluent.

8. The dispersion of claim 7, wherein the macrocyclic oligomer is an oligomer of 1,4-butylene terephthalate.

9. The dispersion of claim 1, wherein the dispersion further contains a comonomer, chain extender, another polymer, an impact modifier or a rubber.

10. A composite of filler particles in a polymer of a macrocyclic oligomer, wherein the composite contains at least 15 weight percent dispersed filler particles.

11. The composite of claim 10, wherein the filler particles have a volume average smallest dimension of about 0.6 nanometer to about 50 nanometers.

12. The composite of claim 11, wherein the filler particles include a layered clay.

13. The composite of claim 12, which contains from 15 to 60% by weight dispersed filler particles.

14. The composite of claim 13, wherein the filler particles have a volume average smallest dimension of up to about 20 nanometers.

15. The composite of claim 14, wherein the macrocyclic oligomer is an oligomer of 1,4-butylene terephthalate, 1,3-propylene terephthalate, 1,4-cyclohexenedimethylene terephthalate, ethylene terephthalate, and 1,2-ethylene-2,6-naphthalenedicarboxylate, or an oligomer of two or more thereof.

16. The composite of claim 13, wherein the composite further contains a diluent.

17. The composite of claim 16 wherein the macrocyclic oligomer is an oligomer of 1,4-butylene terephthalate.

18. The composite of claim 11, wherein the composite further contains a comonomer, chain extender, another polymer, an impact modifier or a rubber.

19. A process for preparing a dispersion of filler particles in a polymer or polymerizable material, comprising
a) forming a masterbatch of filler particles dispersed in a macrocyclic oligomer, wherein the masterbatch contains at least 10 weight percent of dispersed filler particles, and
b) mixing the masterbatch with a polymer or polymerizable material to form a dispersion of the filler particles in a mixture of the macrocyclic oligomer and the polymer or polymerizable material.

20. The process of claim 19, wherein the filler particles have a volume average smallest dimension of about 0.6 nanometer to about 50 nanometers.

21. The process of claim 20, wherein the filler particles include a layered clay.

22. The process of claim 21, wherein the filler particles have a volume average smallest dimension of up to about 20 nanometers.

23. The process of claim 19, further comprising
c) polymerizing the macrocyclic oligomer in the presence of the dispersed filler particles.

24. The process of claim 23, wherein step c) is performed during or after step b).

25. The process of claim 23, wherein step c) is performed prior to step b).

26. The process of claim 19, wherein step a) is conducted in the presence of a diluent.

27. The process of claim 23, wherein step a) is conducted in the presence of a diluent.

28. The process of claim 28, wherein step c) is conducted in the presence of the diluent.

29. The process of claim 23, wherein steps b) and c) are conducted as a single step.

30. The process of claim 30, wherein steps b) and c) are conducted in a reactive extrusion process.

31. The process of claim 29, wherein step a) is conducted in the presence of a diluent.

32. The process of claim 31, wherein step c) is conducted in the presence of the diluent.

33. The process of claim 32, wherein steps b) and c) are conducted as a single step.

34. The process of claim 33, wherein steps b) and c) are conducted in a reactive extrusion process.

35. The process of claim 19, wherein the macrocyclic oligomer is an oligomer of 1,4-butylene terephthalate.

36. The process of claim 19, wherein the masterbatch further contains a comonomer, chain extender, another polymer, an impact modifier or a rubber.
